(19) United States
(12) Patent Application Publication
(10) Pub. No.: US 2024/0083010 A1
(43) Pub. Date: Mar. 14, 2024

(54) Tool Handle

(71) Applicant: Rutabaga Education LLC, San Diego, CA (US)

(72) Inventors: Kaitlin Davidson Mitchell, San Diego, CA (US); Eric Georges Duvauchelle, Temecula, CA (US)

(73) Assignee: Rutabaga Education LLC, San Diego, CA (US)

(21) Appl. No.: 18/508,886

(22) Filed: Nov. 14, 2023

Related U.S. Application Data
(63) Continuation-in-part of application No. 29/834,921, filed on Apr. 14, 2022.

(51) Int. Cl. B25G 1/10; A01B 1/22

(52) U.S. Cl. CPC B25G 1/102; A01B 1/22

(57) ABSTRACT

An omnidirectional tool handle that may be optimized for users with different hand sizes is described. The tool handle may include a curved body with various recesses and protuberances, associated with different usage motions. The tool handle may include various user interface features. The tool handle may be coupled to various tools or implements.

### CROSS-REFERENCE TO RELATED APPLICATIONS

This application is a continuation-in-part of U.S. patent application Ser. No. 29,834,921, filed on Apr. 14, 2022.

### BACKGROUND

Existing gardening tools are not ergonomic and are too large for children or others with smaller hands.

Therefore there is a need for a tool handle that is able to be used in various orientations and is more comfortable for users.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates a front, top, left side perspective view of a tool handle of some embodiments;

FIG. 2 illustrates a rear, bottom, right side perspective view of the tool handle of some embodiments coupled to an example tool insert;

FIG. 3 illustrates a front elevation view of the tool handle of some embodiments;

FIG. 4 illustrates a rear elevation view of the tool handle of some embodiments;

FIG. 5 illustrates a top plan view of the tool handle of some embodiments;

FIG. 6 illustrates a bottom plan view of the tool handle of some embodiments;

FIG. 7 illustrates a left side elevation view of the tool handle of some embodiments;

FIG. 8 illustrates a right side elevation view of the tool handle of some embodiments;

FIG. 9 illustrates a top plan view of the tool handle of some embodiments;

FIG. 10 illustrates a top plan view of the tool handle of some embodiments;

FIG. 11 illustrates a right side elevation view of the tool handle of some embodiments;

FIG. 12 illustrates a right side elevation view of the tool handle of some embodiments;

FIG. 13 illustrates a right side elevation view of the tool handle of some embodiments;

FIG. 14 illustrates a rear, top, left side perspective view of an exemplary tool of some embodiments;

FIG. 15 illustrates a front elevation view of the exemplary tool of some embodiments;

FIG. 16 illustrates a rear elevation view of the exemplary tool of some embodiments;

FIG. 17 illustrates a left side elevation view of the exemplary tool of some embodiments;

FIG. 18 illustrates a top plan view of an alternative tool handle of some embodiments;

FIG. 19 illustrates a bottom plan view of the alternative tool handle of some embodiments;

FIG. 20 illustrates a left side elevation view of the alternative tool handle of some embodiments;

FIG. 21 illustrates a right side elevation view of the alternative tool handle of some embodiments;

FIG. 22 illustrates a top plan view of the alternative tool handle of some embodiments;

FIG. 23 illustrates a top plan view of the alternative tool handle of some embodiments;

FIG. 24 illustrates a right side elevation view of the alternative tool handle of some embodiments;

FIG. 25 illustrates a right side elevation view of the alternative tool handle of some embodiments; and

FIG. 26 illustrates a right side elevation view of the alternative tool handle of some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide an omnidirectional tool handle that may be optimized for users with different hand sizes.

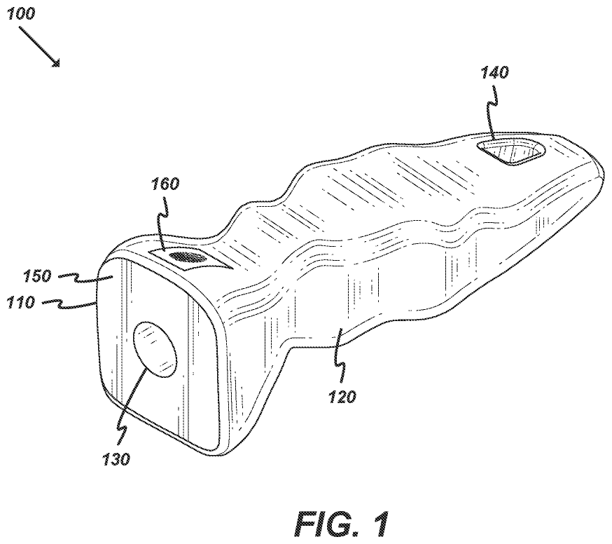

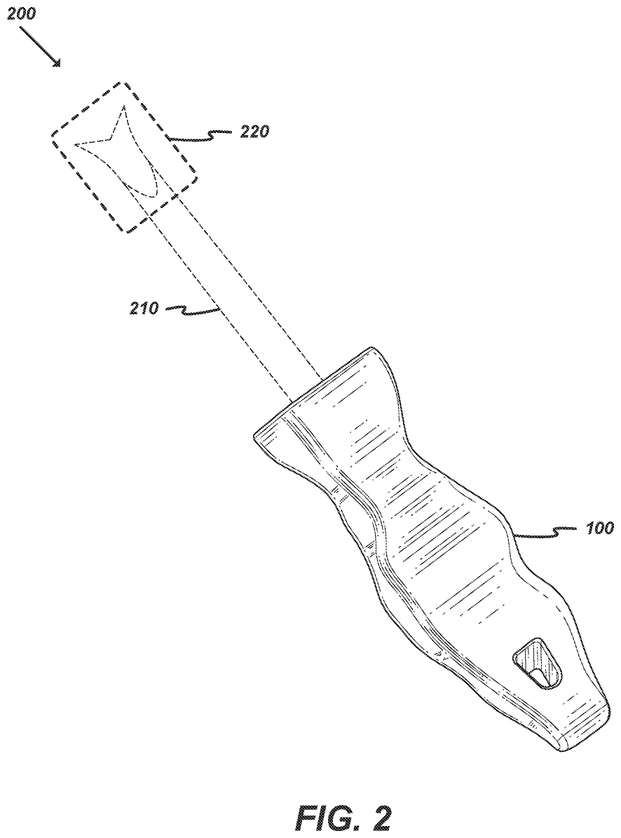

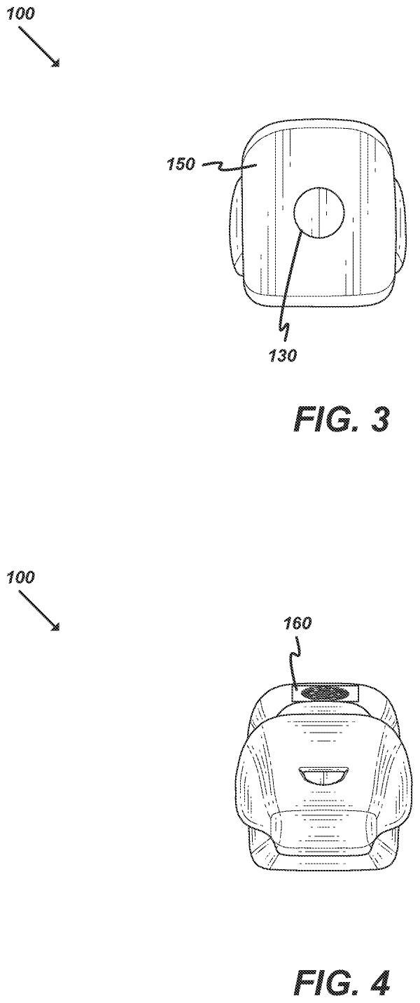

FIG. 1 illustrates a front, top, left side perspective view of a tool handle 100 of some embodiments. FIG. 2 illustrates a rear, bottom, right side perspective view of the tool handle 100 coupled to an example tool 200. FIG. 3 illustrates a front elevation view of the tool handle 100. FIG. 4 illustrates a rear elevation view of the tool handle 100.

Tool handle 100 may include a body 110, a grip portion 120, a tool receptacle 130, a mounting feature 140, face 150, user interface features 160, and/or other appropriate components, such as a frame or skeleton and/or a tool or “tool insert”. Different embodiments of tool handle 100 may have different sizes, shapes, components, etc. as may be appropriate for various different applications (e.g., users with differing hand sizes, different types of tools, and/or other appropriate applications).

Body 110 may be solid material such as plastic, wood, metal, and/or other appropriate materials. In some embodiments, body 110 may include an interior frame or skeleton and an exterior cover or housing molded to the skeleton.

Grip 120 may include various protuberances, recesses, curves, and/or other appropriate elements as shown. Grip 120 may be optimized for multiple usage scenarios. For instance, the grip 120 may allow for a digging or scooping motion with a tool such as a shovel. As another example, the grip 120 may allow for a raking or pulling motion with a tool such as a rake. As still another example, the grip 120 may allow for a pushing motion with a tool such as a weed remover.

Tool receptacle 130 may include a hole or other cavity that is able to accept a portion of a tool. Tool receptacle 130 may be located at or near the center of face 150 as shown. In some embodiments, the tool and skeleton may be formed from a single piece of plastic and/or other appropriate material(s), where the outer surface of body 110 may be molded to the skeleton. In some cases, the tool handle 100 may be coupled to a tool via other features than the tool receptacle 130. For example, the tool handle 100 may be molded onto or about a handle for a watering can.

Mounting feature 140 (e.g., a through-hole) may allow the tool handle 100 to be couple to a hook or peg, attached to a string or strap, and/or otherwise allow the tool handle 100 to be selectively coupled to other components.

Face 150 may include a flat or nearly flat surface in some embodiments, with a rounded rectangular shape as shown.

User interface feature 160 may include various indicators, such as graphics, colors, text, and/or other appropriate elements (e.g., tactile features such as protuberances and/or recesses) that may provide usage information to users, such as proper hand and/or grip position. In this example, user interface feature 160 is a positioning indicator for the thumb, including a thumb print that may include graphics, recesses, protuberances, and/or other appropriate indicators.

Tool 200 may include tool handle 100 and may generally include a connecting member 210 and tool head or implement 220 as shown. In this example, the connecting member 210 is a cylindrical post as shown. Different embodiments may have various different connecting members 210, having different shapes, sizes (e.g., differing length and/or diameter), and/or other appropriate attributes. For example, some embodiments of the tool 200 may include a connecting member 210 that is coupled to multiple implements 220.

In this example, implement 220 is a weeding tool. Different embodiments may include various different implements 220, such as gardening tools, hand tools for metal working or woodworking, cutlery, and/or any other appropriate implements 220.

Tool handle 100 and/or tool 200 may include various rigid or semi-rigid materials, such as plastic, wood, metal, and/or other appropriate materials. In some embodiments, the tool handle 100 may have an exterior skin or grip element (e.g., a rubber or silicone element that surrounds or encloses a portion of the tool handle 100). The tool handle 100 may include materials such as recycled plastic that may be bisphenol A (BPA) free. Such materials may be more durable and long-lasting than existing solutions which may include materials such as aluminum.

One of ordinary skill in the art will recognize that tool handle 100 and/or tool 200 may be implemented in various different ways without departing from the scope of the disclosure. For example, different embodiments may have different sizes, different shapes, different attachments, and/or other different features than shown.

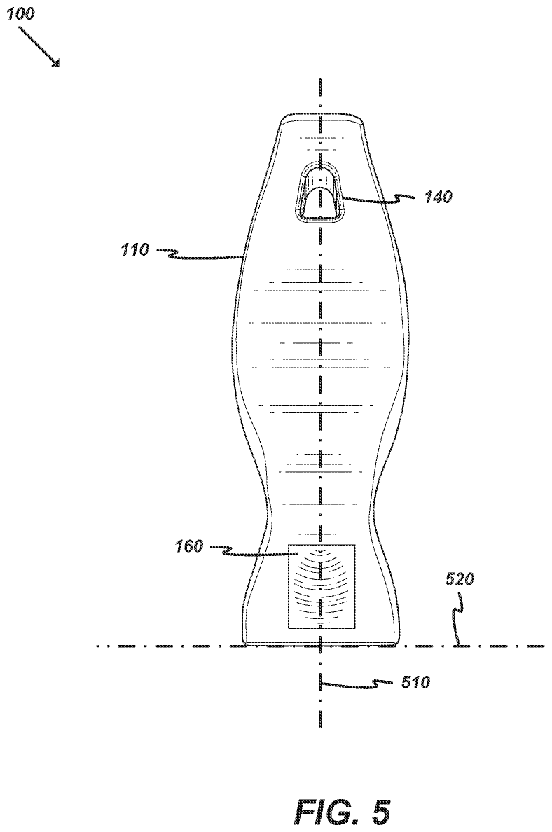

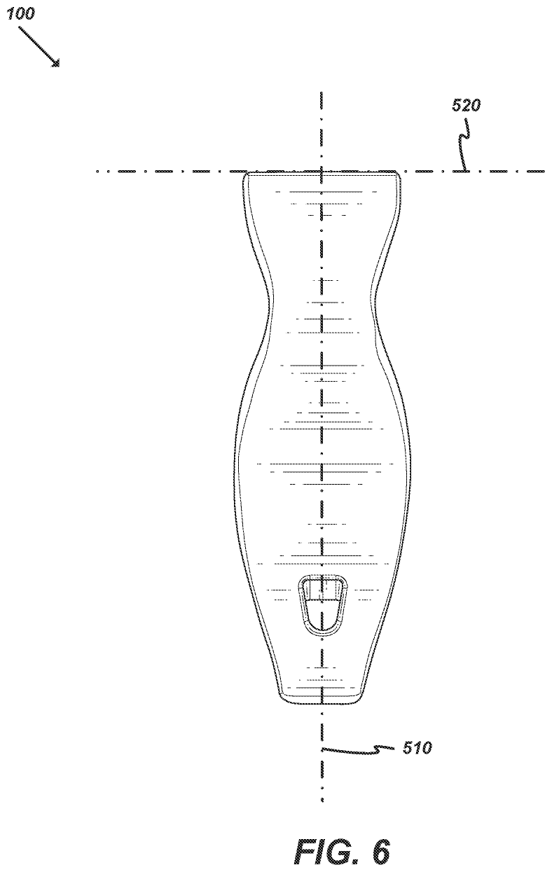

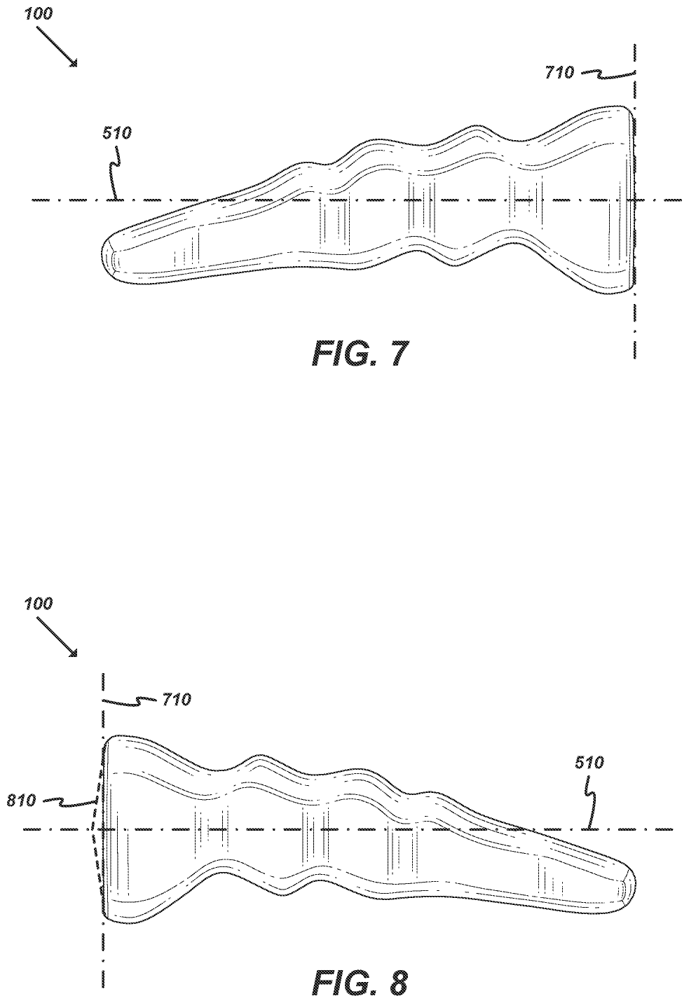

FIG. 5 illustrates a top plan view of the tool handle 100. FIG. 6 illustrates a bottom plan view of the tool handle 100. FIG. 7 illustrates a left side elevation view of the tool handle 100. FIG. 8 illustrates a right side elevation view of the tool handle 100.

As shown, the tool handle 100 may be symmetrical about axis 510 in this view. Face 150 may be parallel to axis 520, where axis 520 is perpendicular to axis 510. Axis 710 may be perpendicular to axis 510 and axis 520.

In the example of FIG. 8, face 150 may have a sloped a sloped or ridged shape 810 (which is symmetrical about axis 510 in this example) that may provide additional support for the connecting member 210 (and/or other components such as the skeleton or body 110), as appropriate for larger tools 200 or tools 200 associated with heavier loads.

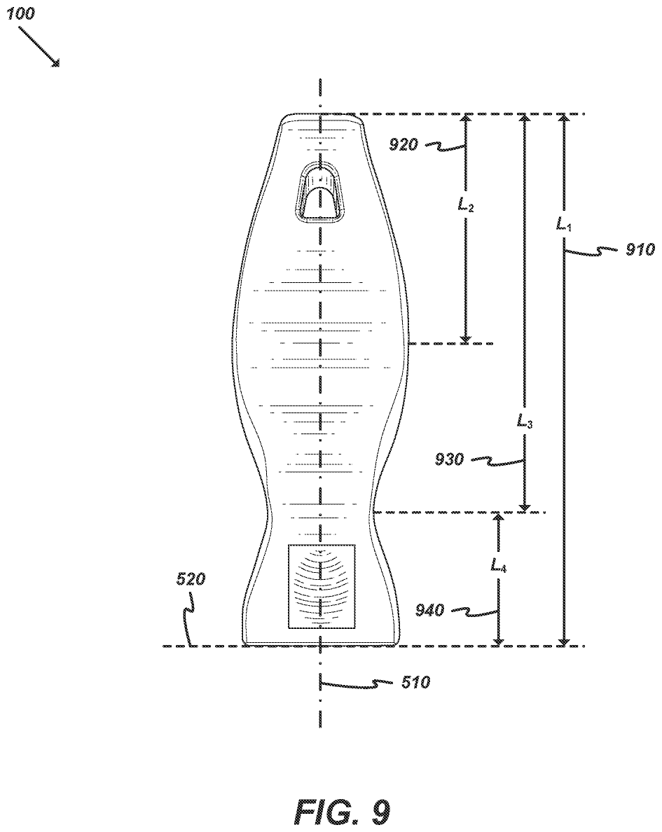

FIG. 9 illustrates a top plan view of the tool handle 100. In this example, the shape of the tool handle 100 may include various ridges and recesses as shown. The overall length, L₁ 910, of the tool handle 100 may be about five inches for a child-sized version. The length to the midpoint of a first ridge, L₂ 920, may be about two-and-one-eighth inches for the child-sized version. The length to the midpoint of a first horizontal recess, L₃ 930, may be about three-and-three-quarters inches. The length from the midpoint of the first horizontal recess to the face 150, L₄ 940, may be about one-and-one-quarter inches. Table 1, below, indicates example target dimensions and ranges for the various lengths 910-940. The dimensions below are provided in inches and have tolerances of plus/minus ten percent. Each of the lengths 910-940 is parallel to axis 510.

TABLE 1

| | Min. | Target | Max. |
|---|---|---|---|
| L₁ | 4.567 | 5.074 | 5.581 |
| L₂ | 1.951 | 2.168 | 2.385 |
| L₃ | 3.396 | 3.773 | 4.150 |
| L₄ | 1.129 | 1.254 | 1.379 |

Table 2, below, indicates example ratios of the various lengths, with the overall length, L₁ 910, used as a unit value (i.e., all ratios are relative to the target L₁ 910). As above, this example includes tolerances of plus/minus ten percent.

TABLE 2

| | Min. | Target | Max. |
|---|---|---|---|
| L₁ | | 1.000 | |
| L₂ | 0.385 | 0.427 | 0.470 |
| L₃ | 0.669 | 0.744 | 0.818 |
| L₄ | 0.222 | 0.247 | 0.272 |

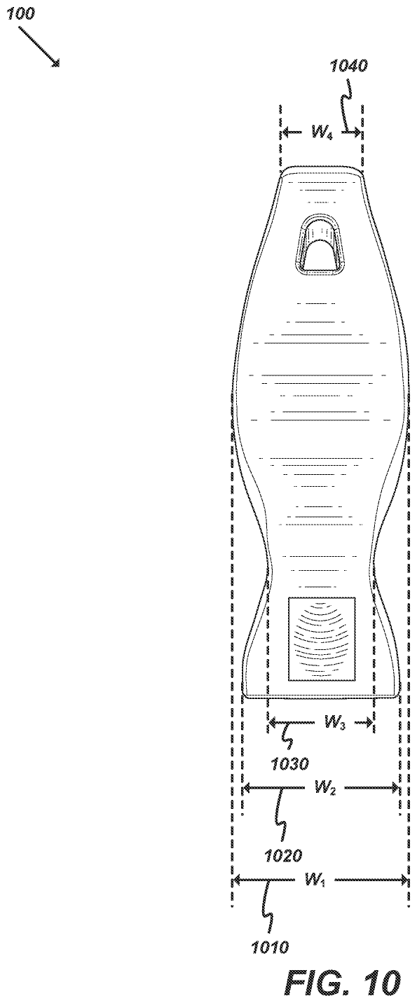

FIG. 10 illustrates a top plan view of the tool handle 100. In this example, the shape of the tool handle 100 may include various ridges and recesses as shown. The grip width, W₁ 1010, of the tool handle 100 may be about one-and-five-eighths inches for a child-sized version. The width of the face 150, W₂ 1020, may be about one-and-one-half inches for the child-sized version. The width of the first horizontal recess, W₃ 1030, may be about one inch. The width of the distal end of the handle 100, W₄ 1040, may be about three-quarters of an inch. Table 3, below, indicates example target dimensions and ranges for the various widths 1010-1040. The dimensions below are provided in inches and have tolerances of plus/minus ten percent. Each of the widths 1010-1040 is parallel to axis 520.

TABLE 3

| | Min. | Target | Max. |
|---|---|---|---|
| W₁ | 1.490 | 1.656 | 1.822 |
| W₂ | 1.329 | 1.477 | 1.625 |
| W₃ | 0.889 | 0.988 | 1.087 |
| W₄ | 0.675 | 0.750 | 0.825 |

Table 4, below, indicates example ratios of the various widths, with the overall length, L₁ 910, used as a unit value (i.e., all ratios are relative to the target L₁ 910). As above, this example includes tolerances of plus/minus ten percent.

TABLE 4

| | Min. | Target | Max. |
|---|---|---|---|
| W₁ | 0.294 | 0.326 | 0.359 |
| W₂ | 0.262 | 0.291 | 0.320 |
| W₃ | 0.175 | 0.195 | 0.214 |
| W₄ | 0.133 | 0.148 | 0.163 |

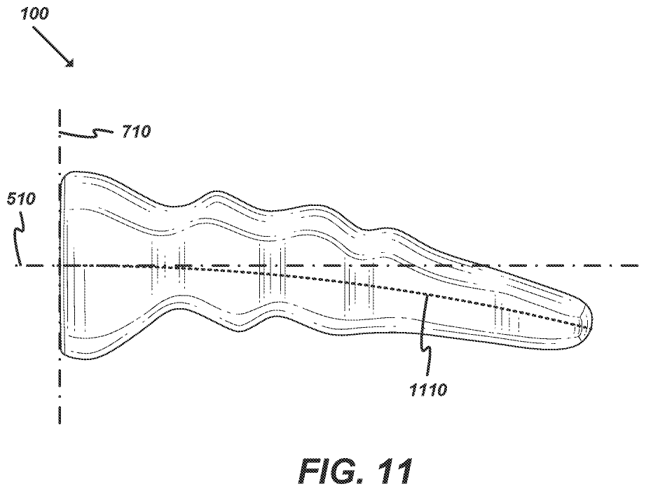

FIG. 11 illustrates a right side elevation view of the tool handle 100. As shown, the center and/or middle of tool handle 100 may follow a curve 1110 rather than a straight line 510. In this example, curve 1110 may have a target radius of about twenty-one and two-tenths inches, associated with a target ratio of four and one hundred seventy-eight thousandths (4.178) relative to the overall length, L₁ 910.

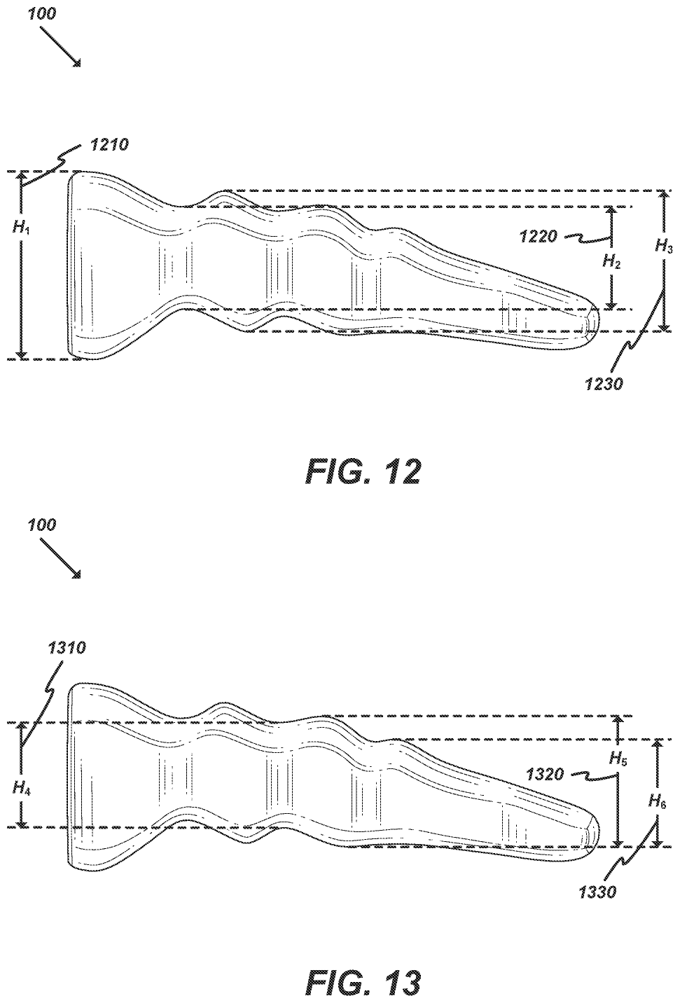

FIG. 12 illustrates a right side elevation view of the tool handle 100. FIG. 13 illustrates a right side elevation view of the tool handle 100. In this example, the shape of the tool handle 100 may include various ridges and recesses as shown. The face height, H₁ 1210, of the tool handle 100 may be about one-and-three-quarters inches for a child-sized version. The height of a first vertical recess, H₂ 1220, may be about one inch for the child-sized version. The height of the first set of vertical protuberances, H₃ 1230, may be about one-and-one-third inches. The height of a second vertical recess, H₄ 1310, may be about one inch. The height of a second set of vertical protuberances, H₅ 1320, may be about one-and-one-quarter inches. The height of a third set of vertical protuberances, H₆ 1330, may be about one inch. Table 5, below, indicates example target dimensions and ranges for the various heights 1210-1230 and 1310-1330. The dimensions below are provided in inches and have tolerances of plus/minus ten percent. Each of the heights 1210-1230 and 1310-1330 is parallel to axis 710.

TABLE 5

| | Min. | Target | Max. |
|---|---|---|---|
| H₁ | 1.596 | 1.773 | 1.950 |
| H₂ | 0.879 | 0.977 | 1.075 |
| H₃ | 1.202 | 1.336 | 1.470 |
| H₄ | 0.907 | 1.008 | 1.109 |
| H₅ | 1.125 | 1.250 | 1.375 |
| H₆ | 0.914 | 1.016 | 1.118 |

Table 6, below, indicates example ratios of the various heights, with the overall length, L₁ 910, used as a unit value (i.e., all ratios are relative to the target L₁ 910). As above, this example includes tolerances of plus/minus ten percent.

TABLE 6

| | Min. | Target | Max. |
|---|---|---|---|
| H₁ | 0.314 | 0.349 | 0.384 |
| H₂ | 0.173 | 0.193 | 0.212 |
| H₃ | 0.237 | 0.263 | 0.290 |
| H₄ | 0.179 | 0.199 | 0.219 |
| H₅ | 0.222 | 0.246 | 0.271 |
| H₆ | 0.180 | 0.200 | 0.220 |

An adult version of the tool handle 100 may be about thirty percent larger than the child version. In some embodiments, different sizes may be provided across tool handle type. For example, small, medium, and large sizes may be provided for a child version and for an adult version. One of ordinary skill in the art will recognize that different embodiments may have different specific dimensions and/or ratios than described above. For instance, some embodiments may have tighter tolerances than specified (e.g., within plus/minus five percent, two percent, or one percent rather than ten percent).

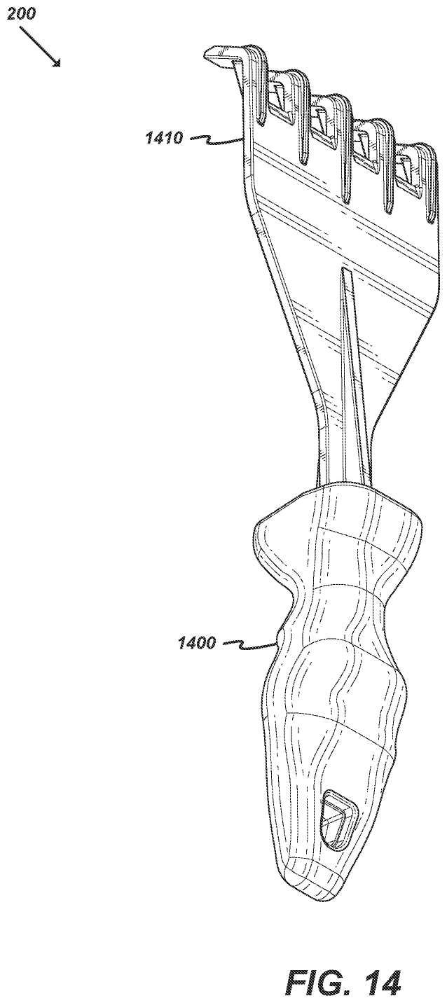

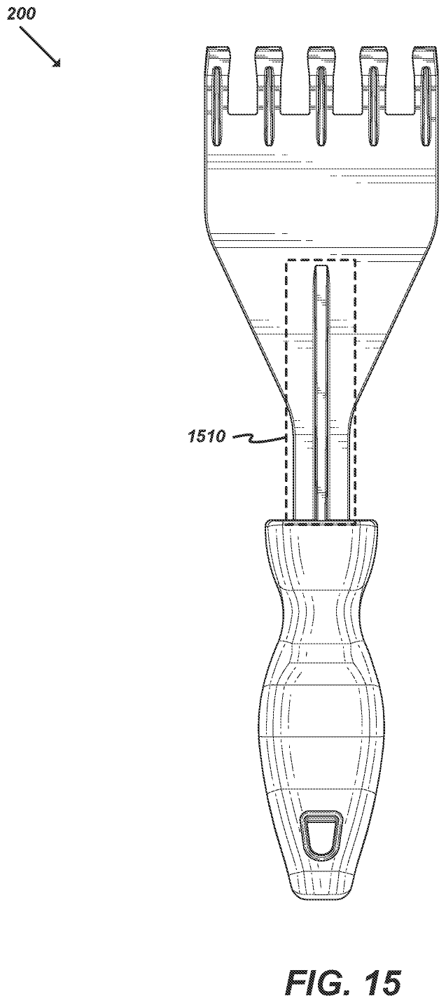

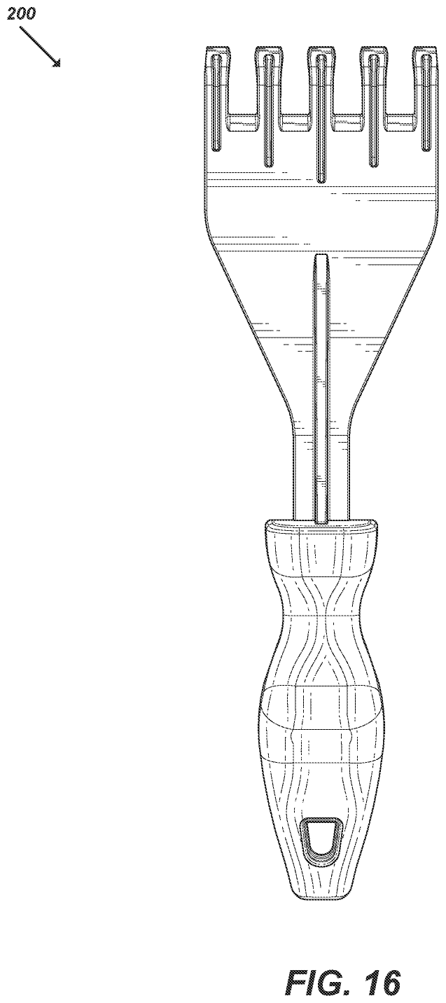

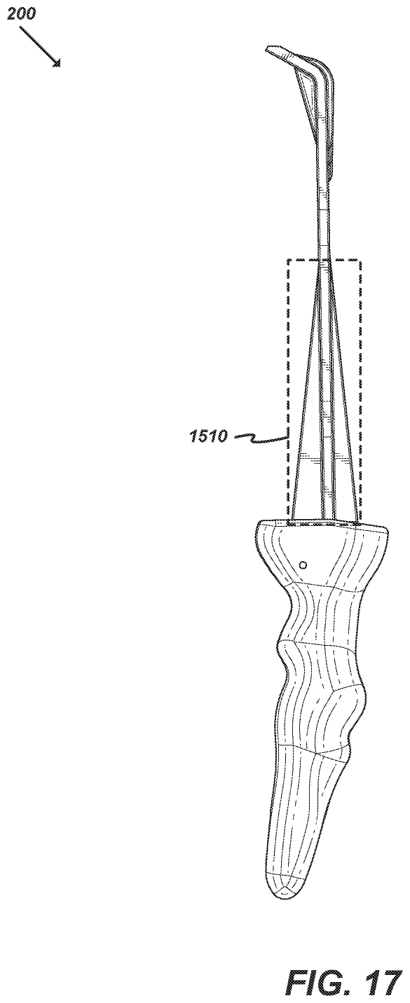

FIG. 14 illustrates a rear, top, left side perspective view of an exemplary tool 200 of some embodiments. FIG. 15 illustrates a front elevation view of the exemplary tool 200. FIG. 16 illustrates a rear elevation view of the exemplary tool 200. FIG. 17 illustrates a left side elevation view of the exemplary tool 200.

In this example, the gardening tool 200 includes an alternative tool handle 1400 and a rake-type tool insert 1410. Tool insert 1410 may include both an alternative connecting member 1510 and tool head 220 described above, as shown. In this example the tool head 220 is integrated with a rigid connecting member 1510 including perpendicular planar elements. The tool body 110 of the alternative tool handle 1400 may have a similar shape to that of tool handle 100, where the differences will be highlighted in the discussion below.

Each tool insert 1410 may be sized for the intended usage. For instance, a tool 200 intended for a child may have a smaller tool head 220 and/or connecting member 210 than a tool intended for an adult. As another example, a scoop or shovel tool 200 intended for a child may have a smaller capacity than such a tool intended for an adult. As another example, a watering can associated with tool handle 1400 may have a smaller capacity for a tool 200 intended for a child than for an adult. Similarly, a small or medium tool 200 may have less capacity than a large tool 200.

One of ordinary skill in the art will recognize that various features described herein may be combined in various appropriate ways. For instance, tool handle 100 may be coupled to tool insert 1410. As another example, tool head 220 may be coupled to connecting member 1510, which may be coupled to tool handle 100 or alternative tool handle 1400.

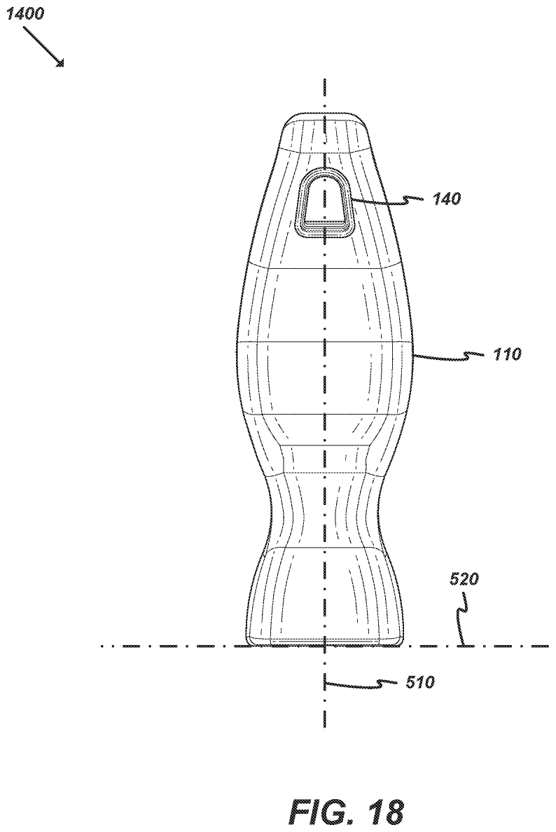

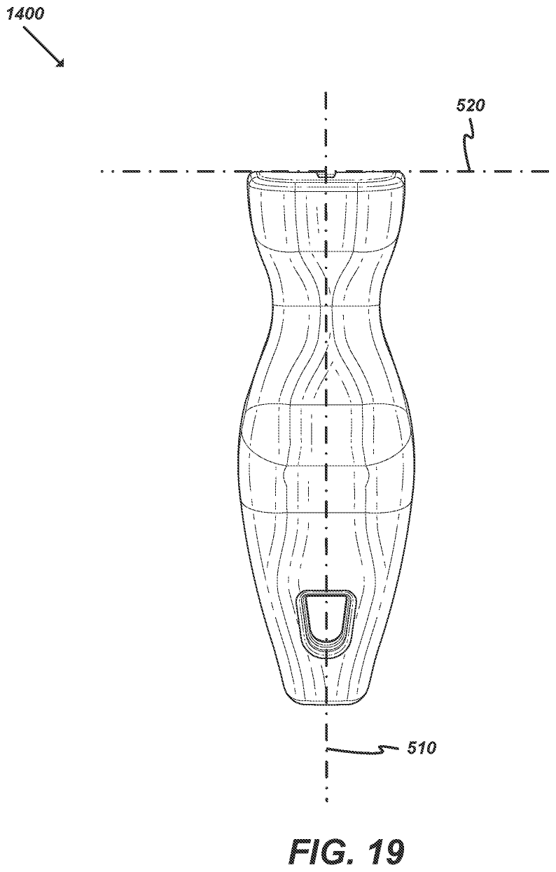

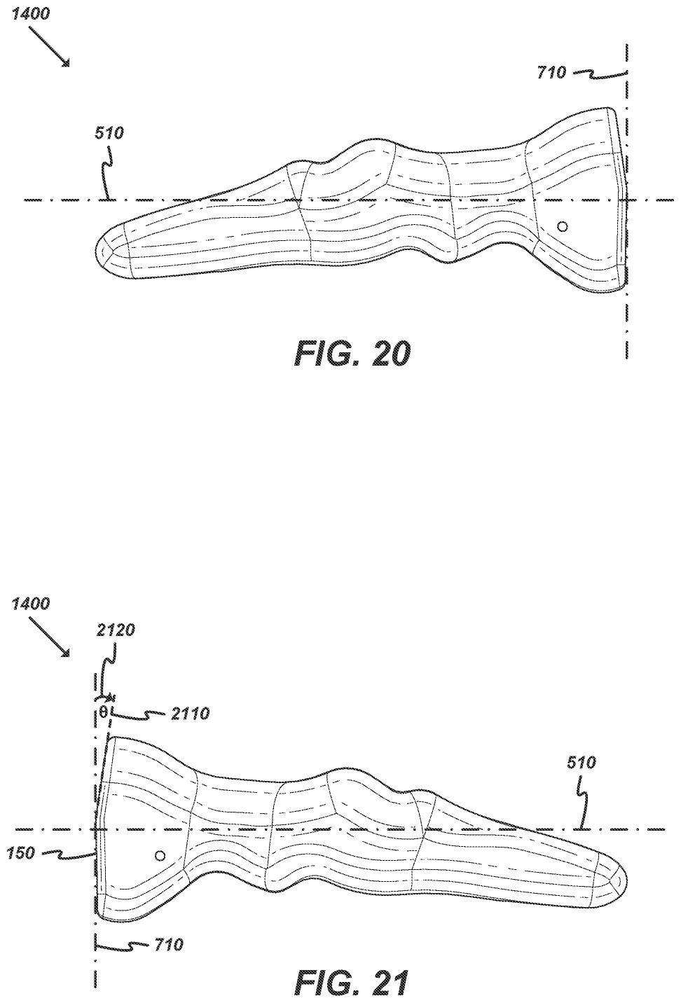

FIG. 18 illustrates a top plan view of an alternative tool handle 1400 of some embodiments. FIG. 19 illustrates a bottom plan view of the alternative tool handle 1400. As shown, the alternative tool handle 1400 may be symmetrical about axis 510 in this view. FIG. 20 illustrates a left side elevation view of the alternative tool handle 1400. FIG. 21 illustrates a right side elevation view of the alternative tool handle 1400.

At least a portion of face 150 may be parallel to axis 520, as shown. In this example, a portion of face 150 slopes away from axis 710 along line 2110, forming a ridged or sloped shape 810 that is not symmetrical with axis 510 in this example and orientation. In this example, the offset angle θ 2120 of line 2110 relative to axis 710 may be between eight and nine degrees in some embodiments and may be associated with a planar surface along alternative tool handle 1400 that forms a portion of face 150.

The sloped or ridged face 150 may provide additional support for the connecting member 210 or 1510 (and/or other components such as the skeleton or body 110), as appropriate for larger tools 200 or tools 200 associated with heavier loads.

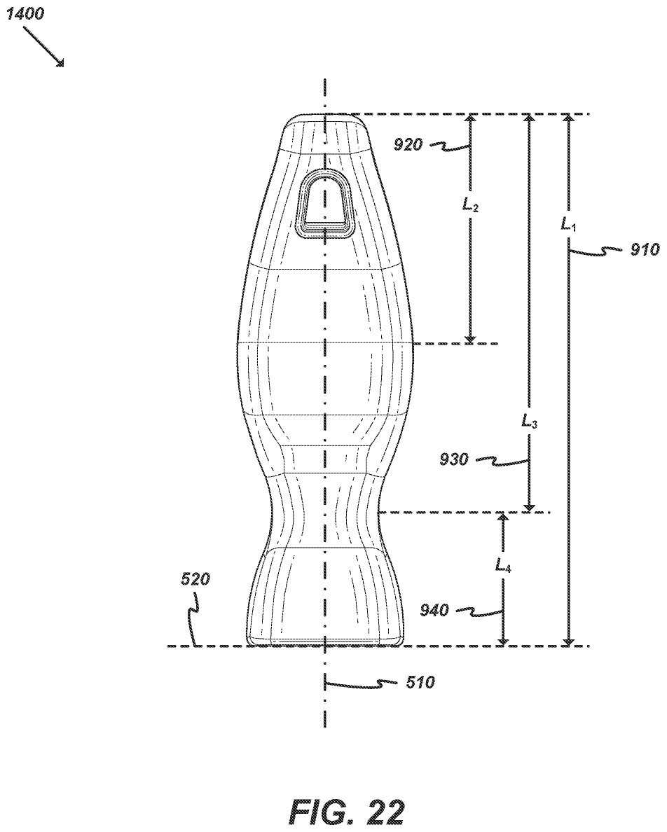

FIG. 22 illustrates a top plan view of the alternative tool handle 1400. Similar to tool handle 100, alternative tool handle 1400 may include various ridges and recesses as shown. As shown, the sizing and configuration along the length of the alternative tool handle 1400 may be the same as tool handle 100.

The overall length, L₁ 910, of the alternative tool handle 1400 may be about five inches for a child-sized version. The length to the midpoint of a first ridge, L₂ 920, may be about two-and-one-eighth inches for the child-sized version. The length to the midpoint of a first horizontal recess, L₃ 930, may be about three-and-three-quarters inches. The length from the midpoint of the first horizontal recess to the face 150, L₄ 940, may be about one-and-one-quarter inches. Table 1, above, indicates example target dimensions and ranges for the various lengths 910-940. The dimensions above are provided in inches and have tolerances of plus/minus ten percent. Each of the lengths 910-940 is parallel to axis 510.

Table 2, above, indicates example ratios of the various lengths, with the overall length, L₁ 910, used as a unit value (i.e., all ratios are relative to the target L₁ 910). As above, this example includes tolerances of plus/minus ten percent.

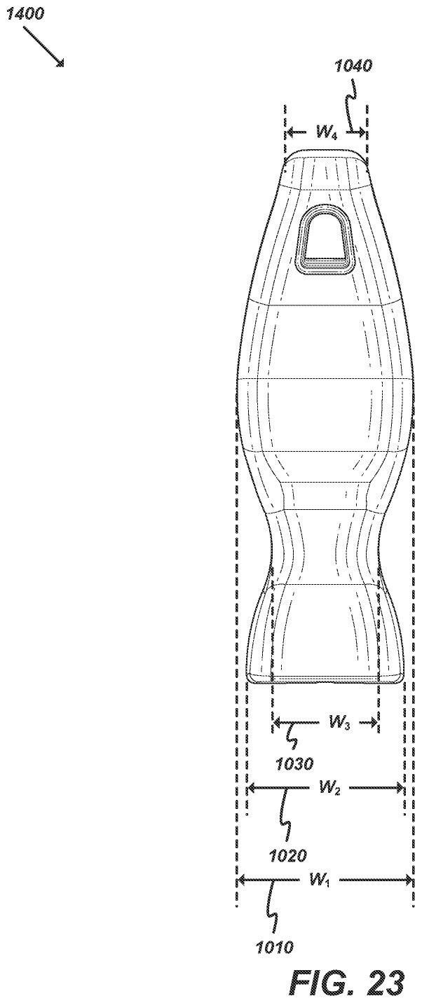

FIG. 23 illustrates a top plan view of the alternative tool handle 1400. Similar to tool handle 100, alternative tool handle 1400 may include various ridges and recesses as shown. As shown, the sizing and configuration along the width of the alternative tool handle 1400 may be the same as tool handle 100.

The grip width, W₁ 1010, of the alternative tool handle 1400 may be about one-and-five-eighths inches for a child-sized version. The width of the face 150, W₂ 1020, may be about one-and- one-half inches for the child-sized version. The width of the first horizontal recess, ₃ 1030, may be about one inch. The width of the distal end of the handle 100, W₄ 1040, may be about three-quarters of an inch. Table 3, above, indicates example target dimensions and ranges for the various widths 1010-1040. The dimensions below are provided in inches and have tolerances of plus/minus ten percent. Each of the widths 1010-1040 is parallel to axis 520.

Table 4, above, indicates example ratios of the various widths, with the overall length,

L₁ 910, used as a unit value (i.e., all ratios are relative to the target L₁ 910). As above, this example includes tolerances of plus/minus ten percent.

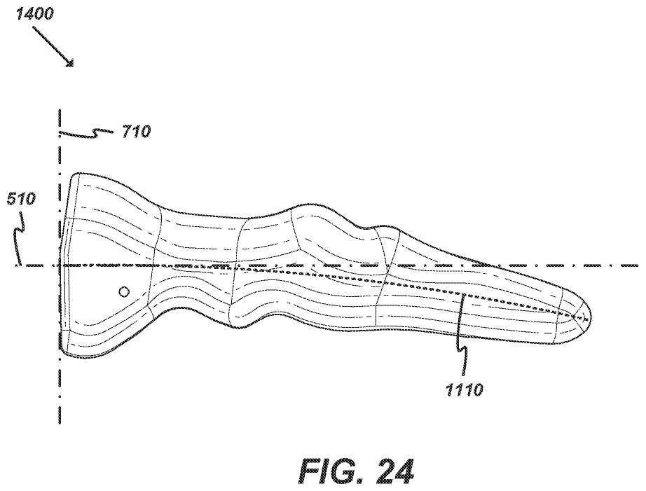

FIG. 24 illustrates a right side elevation view of the alternative tool handle 1400. As shown, the center and/or middle of alternative tool handle 1400 may follow curve 1110 (similar to tool handle 100) rather than a straight line 510. In this example, curve 1110 may have a target radius of about twenty-one and two-tenths inches, associated with a target ratio of four and one hundred seventy-eight thousandths (4.178) relative to the overall length, L₁ 910.

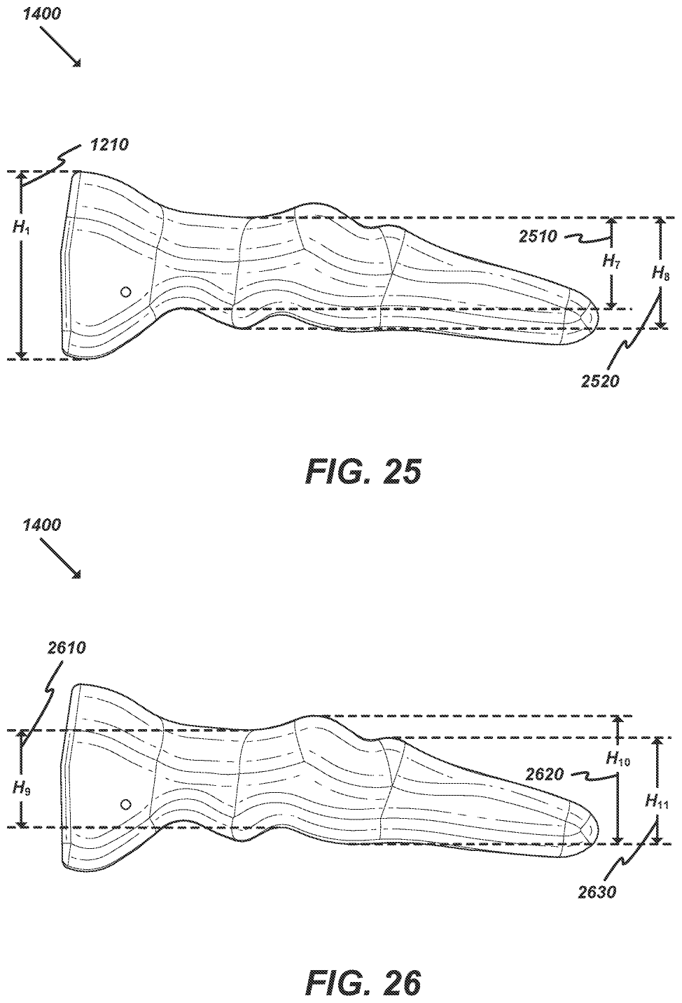

FIG. 25 illustrates a right side elevation view of the alternative tool handle 1400. FIG. 26 illustrates a right side elevation view of the alternative tool handle 1400. As shown, the top-side protuberance from the first set of vertical protuberances associated with tool handle 100 has been removed and/or replaced by an elongated recess.

In this example, the shape of the alternative tool handle 1400 may include various ridges and recesses as shown. The face height, H₁ 1210, of the alternative tool handle 1400 may be about one-and-three-quarters inches for a child-sized version. The height of a first vertical recess, H₇ 2510, may be about seven-eighths of an inch for the child-sized version. The height of the bottom-side vertical protuberance relative to the first vertical recess, H₈ 2520, may be about one-and-six-hundredths inches. The height of a second vertical recess, H₉ 2610, may be about fifteen-sixteenths of an inch. The height of a second set of vertical protuberances, H₁₀ 2620, may be about one-and-one-fifth to one-and-one quarter inches. The height of a third set of vertical protuberances, H₁₁ 2630, may be about one inch. Table 5, above, indicates example target dimension and range for height 1210. Table 7, below, indicates example target dimensions and ranges for the various heights 2510, 2520, and 2610-2630. The dimensions above and below are provided in inches and have tolerances of plus/minus ten percent. Each of the heights 1210, 2510, 2520, and 2610-2630 is parallel to axis 710.

TABLE 7

| | Min. | Target | Max. |
|---|---|---|---|
| H₇ | 0.784 | 0.871 | 0.958 |
| H₈ | 0.954 | 1.060 | 1.166 |
| H₉ | 0.841 | 0.934 | 1.027 |
| H₁₀ | 1.097 | 1.219 | 1.341 |
| H₁₁ | 0.907 | 1.008 | 1.109 |

Table 6 above and Table 8 below, indicate example ratios of the various heights, with the overall length, L₁ 910, used as a unit value (i.e., all ratios are relative to the target L₁ 910). As above, this example includes tolerances of plus/minus ten percent.

TABLE 8

| | Min. | Target | Max. |
|---|---|---|---|
| H₇ | 0.155 | 0.172 | 0.189 |
| H₈ | 0.188 | 0.209 | 0.223 |
| H₉ | 0.166 | 0.184 | 0.202 |
| H₁₀ | 0.216 | 0.240 | 0.264 |
| H₁₁ | 0.179 | 0.199 | 0.219 |

An adult version of the alternative tool handle 1400 may be about thirty percent larger than the child version. In some embodiments, different sizes may be provided across tool handle type. For example, small, medium, and large sizes may be provided for a child version and for an adult version. One of ordinary skill in the art will recognize that different embodiments may have different specific dimensions and/or ratios than described above. For instance, some embodiments may have tighter tolerances than specified (e.g., within plus/minus five percent, two percent, or one percent rather than ten percent).

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A tool handle comprising:
a curved body;
a set of recesses and protuberances along the curved body; and
a tool receptacle.

2. The tool handle of claim 1 further comprising at least one user interface feature.

3. The tool handle of claim 1, wherein the set of recesses and protuberances comprises:
a horizontal recess;
a first vertical recess; and
a second vertical recess.

4. The tool handle of claim 3, wherein the set of recesses and protuberances comprises:
a first set of vertical protuberances;
a second set of vertical protuberances; and
a third set of vertical protuberances.

5. The tool handle of claim 1, wherein the curved body follows a radius that is four times an overall length of the tool handle.

6. The tool handle of claim 1, wherein the tool handle has an overall length of about five inches.

7. The tool handle of claim 6, wherein the tool handle has an overall width of about one-third the overall length.

8. A gardening tool comprising:
a tool handle comprising:
a curved body;
a set of recesses and protuberances along the curved body; and
a tool receptacle; and
a tool insert coupled to the tool receptacle.

9. The gardening tool of claim 8, wherein the tool handle comprises at least one user interface feature.

10. The gardening tool of claim 8, wherein the set of recesses and protuberances comprises:
a horizontal recess;
a first vertical recess; and
a second vertical recess.

11. The gardening tool of claim 10, wherein the set of recesses and protuberances comprises:
a first set of vertical protuberances;
a second set of vertical protuberances; and
a third set of vertical protuberances.

12. The gardening tool of claim 8, wherein the curved body follows a radius that is four times an overall length of the tool handle.

13. The gardening tool of claim 8, wherein the tool handle has an overall length of about five inches and wherein the tool handle has an overall width of about one-third the overall length.

14. The gardening tool of claim 8, wherein the tool insert comprises at least one of a shovel, scoop, rake, and weed tool.

15. A handle comprising:
a curved body;
a set of recesses and protuberances along the curved body;
a tool receptacle; and
at least one user interface feature.

16. The handle of claim 15, wherein the at least one user interface feature indicates a position for a thumb of a user.

17. The handle of claim 15, wherein the set of recesses and protuberances comprises:
a horizontal recess;
a first vertical recess; and
a second vertical recess.

18. The handle of claim 17, wherein the set of recesses and protuberances comprises:
a first set of vertical protuberances;
a second set of vertical protuberances; and
a third set of vertical protuberances.

19. The handle of claim 15, wherein the curved body follows a radius that is four times an overall length of the tool handle.

20. The handle of claim 15, wherein the tool handle has an overall length of about five inches and wherein the tool handle has an overall width of about one-third the overall length.
